(19) United States
(12) Patent Application Publication
(10) Pub. No.: US 2009/0020488 A1
(43) Pub. Date: Jan. 22, 2009

(54) SHATTERPROOF URN

(76) Inventor: MARILYN TURKEL, SANTA ROSA, CA (US)

Correspondence Address: STAINBROOK & STAINBROOK, LLP, 412 AVIATION BOULEVARD, SUITE H, SANTA ROSA, CA, 95403, US

(21) Appl. No.: 12/174,421

(22) Filed: Jul. 16, 2008

Related U.S. Application Data
(60) Provisional application No. 60/949,900, filed on Jul. 16, 2007.

(51) Int. Cl. A61G 17/08

(52) U.S. Cl. 211/85.27

(57) ABSTRACT

A shatterproof urn for the final disposition of cremation remains that includes an outer shell defining an interior volume and having an interior surface and an opening for the placement and removal of contents from the interior volume. The outer shell is fabricated from a hard and durable material. A resilient and/or flexible lining is disposed on the interior surface of the outer shell and may partly adhere to the interior surface. A lid is provided and is sized for sealed placement over the opening in the outer shell, and the lid is also provided with a resilient material on its underside. If for any reason the urn is broken, the flexible inner lining remains intact and prevents sharp outer shell material from damaging urn contents.

### CROSS REFERENCES TO RELATED APPLICATIONS

The present application claims the benefit of the filing date of U.S. Provisional Patent Application Ser. No. 60/949,900, filed Jul. 16, 2007 (Jul. 16, 2007).

### SEQUENCE LISTING

Not applicable.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Field of the Invention

The present invention relates generally to containers for cremation remains, and more particularly to a shatterproof urn for displaying and protecting cremation remains.

2. Discussion of Related Art Including Information Disclosed Under 37 CFR §§1.97, 1.98

Some states in the United States require that containers for the cremated remains of a person be durable and shatterproof. Industry has responded by providing a number of solutions, most commonly employing a shatterproof container that holds a sealed bag or other interior receptacle for holding the remains. Ashes and other remains are typically placed inside the urn in a sealed plastic bag and a shatterproof urn is provided to ensure that sharp edges of shards or other broken ceramic (or glass) pieces will not cut the bag and expose its contents.

Exemplary solutions may be found in the following patents:

U.S. Pat. No. 5,732,452 to Riedel, II, teaches a dual-layer burial urn having a hollow decorative casing surrounding an inner resilient liner made from a high-impact plastic. The outer casing is made of a durable and break resistant base resin, such as an acrylic or polymeric material and inert fillers. The outer and inner layers contain openings that cooperate to provide access for placement of the remains.

U.S. Pat. No. 2,562,726, to MacDonald, et al, discloses a crematory urn with a glass liner and an ornamental outer layer which is resistant to shock, stress, strains, cracking, warping, etc. In this disclosure, there is shown an urn in which the outer layer protects the remains from loss due to breakage.

U.S. Pat. No. 4,648,162, to Daino, teaches a cremation urn having an upper portion made from a plurality of stained glass panels mounted on a base made from an acrylic. The base has foam on its upper surface to seal the space between the base and the upper portion and to act as a cushion to prevent rattling of cremation remains. Also a paper board liner is secured in place along the inner edges of the urn to prevent the cremation remains placed in the urn from being visible through the stained glass sides. The paper liner is not provided to prevent shattering, but only to render the stained glass opaque so that the remains cannot be viewed.

U.S. Pat. No. 5,740,637, to Snow, shows a cremation remains container comprising a concrete block with a cavity, and a separate molded plastic liner fitted into the cavity. The liner is to provide a hermetic seal within the cavity. There is no indication that the liner will prevent the block from shattering.

U.S. Pat. No. 5,349,727, to Niebergall, discloses a cremation remains storage container having an outer decorative shell. It is made from an opaque material and has a lid providing access to the interior, which includes a removable inner (transparent) container made from a rigid plastics material with a sealable cap for containing cremation ashes. The inner container is not provided to prevent shattering of the outer container.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

Those skilled in the art will appreciate that the conception, upon which this disclosure is based may readily be used as a basis for designing other structures, methods, and systems for carrying out the several purposes of the present invention. For a better understanding of the present invention, its advantages and the specific objects attained by its uses, reference should be made to the accompanying drawings and descriptive matter in which there are illustrated the preferred embodiments.

### SUMMARY OF THE INVENTION

The present invention may be likened to the membrane of an egg shell. An urn, either ceramic, glass, or other chemically inert and durable material suitable for decoratively holding cremated human remains, is provided with a resilient interior coating, or interior membrane, which is either fully or partly adhered to the interior surface of the container. The membrane is preferably made from a urethane, natural rubber, or synthetic rubber, and it functions to provide increased structural integrity to the urn itself, while also holding broken pieces together in the event the fragile exterior container is broken or shattered. The durometer (shore hardness) rating of the interior coating material is sufficiently high to prevent movement of the broken pieces that would potentially expose sharp edges to the coating material.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a perspective view of an exemplary decorative urn that may embody the technology of the present invention; and

FIG. 2 is a cross-sectional side view in elevation of the urn of FIG. 1.

### DETAILED DESCRIPTION OF THE INVENTION

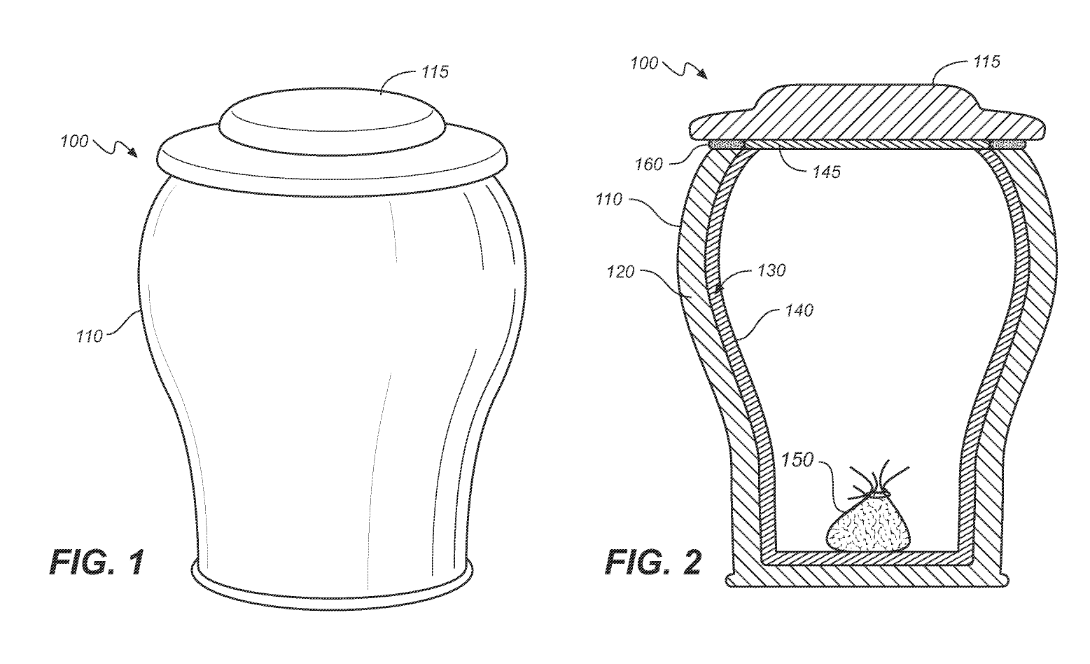

Referring to FIGS. 1 and 2, wherein like reference numerals refer to like components in the various views, there is illustrated therein a new and improved urn for use in containing and protecting human remains and ashes after cremation. The inventive urn is generally denominated 100 herein. In its most essential aspect, the inventive urn first comprises a ceramic, glass, or other material shell 110. The shell provides a substantially enclosed container but includes an opening for inserting and removing material from the interior volume. The opening is provided with a mating lid 115 that is removable when inserting remains and is sealed with a resilient adhesive 160 when remains are securely placed inside the urn for interment. The shell and lid may be fabricated from glass, ceramic, glass-ceramic, organic thermoplastic or thermosetting polymer, metal alloys, or other hard and durable material 120, chosen both for its durability and for its decorative features. Importantly, the urn material may be chosen in order to support a durable surface decoration. As such, depending on the particular material chosen and the material dimensions of the urn container, the urn material may be breakable, perhaps even fragile.

The interior side or surface 130 of the shell and the underside of lid 115 are each coated with a flexible, partly resilient lining 140, 145, respectively, that adheres, in whole or in part, to the shell interior and the lid underside surfaces. Liquid coating processes for applying the resilient lining to the shell and lid are well known, and include spraying, dipping, blade or brush, deposition, and the like.

A number of materials have been tested for suitability for the coating used in the present invention, including several liquid rubbers and urethane rubber compounds. A urethane rubber with a measured durometer of 35 shoreA hardness shows sufficient adhesion, but a very thick coat is required to prevent damage to the coating and to prevent the unwanted exposure of interior contents (cremation/ash remains) when the urn is broken. A liquid urethane rubber with a 80 shoreA hardness has been found to be particularly well suited for an urn having a inner lining comprising a single interior coating having a thickness sufficient to hold pieces together when the urn is broken by dropping. An example of a readily available off-the-shelf product for such an application is a liquid urethane product selling under the brand name of Smooth-On PMC 780, manufactured by Smooth On of Easton, Pa. Accordingly, the preferred shoreA hardness of the resilient lining is between approximately 35 shoreA and 80 shoreA hardness.

In an alternative embodiment, the resilient inner lining may be fabricated from a urethane that does not fully adhere, or only loosely adheres, to the interior wall of the urn. Accordingly, when exposed to a breaking force, some or all of the ceramic pieces may separate during the impact and release from the urethane coating, thereby leaving an intact flexible “balloon” of urethane that protects the cremation remains contents, which are typically contained in a sealed plastic bag 150. The pottery shards are prevented from disturbing the contents by the flexible urethane balloon.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A shatterproof urn, comprising:
a shell defining an interior volume, and having an interior surface and an opening for the placement and removal of contents from the interior volume, said shell fabricated from a hard and durable material;
a lid sized for sealed placement over the opening in said shell, said lid having an underside exposed to the interior volume of said shell and being fabricated from a hard and durable material;
a sealing material disposed between said lid and said outer shell; and
a resilient lining disposed on said interior surface of said shell and on said underside of said lid.

2. The apparatus of claim 1, wherein the material from which said shell and said lid are made is selected from the group consisting of glass, ceramic, glass-ceramic, organic thermoplastic, and thermosetting polymer

3. The apparatus of claim 1, wherein the material from which said shell and said lid are made is a metal alloy.

4. The apparatus of claim 1, wherein said sealing material is a resilient adhesive

5. The apparatus of claim 1, wherein said resilient lining adheres to said interior surface of said shell and said underside of said lid.

6. The apparatus of claim 5, wherein said resilient lining is applied to said shell interior surface and to said underside of said lid by either spraying, dipping, blade, brush, or deposition.

7. The apparatus of claim 1, wherein said resilient lining is fabricated from a material selected from liquid rubber and urethane rubber compounds.

8. The apparatus of claim 7, wherein said resilient lining is fabricated from a urethane rubber with a measured durometer of between about 35 shoreA hardness and about 80 shoreA hardness.

9. The apparatus of claim 1, wherein said resilient inner lining loosely adheres to said interior surface of said shell, such that when said urn is broken, some or all of the shell pieces release from said resilient lining, thus leaving an intact flexible balloon of lining material that protects the shell contents.

10. A shatterproof urn, comprising:
a hard and durable shell having an interior surface enclosing an interior space and an opening for placing and removing contents from said interior space;
a hard and durable lid for covering the opening in said shell; and
a resilient interior lining at least partly adhering to said interior surface of said shell.

11. The apparatus of claim 10, wherein said lid has an underside and said underside includes a resilient lining fabricated from the same material from which said resilient lining on said interior surface is fabricated.

12. The apparatus of claim 10, further including a sealant disposed between said lid and said shell.

13. The apparatus of claim 10, wherein said shell is fabricated from a material selected from the group consisting of glass, ceramic, glass-ceramic, plastic, organic thermoplastic, and thermosetting polymer.

14. The apparatus of claim 10, wherein said interior lining is fabricated from a material selected from liquid rubber and urethane rubber compounds.

15. The apparatus of claim 10, wherein said interior lining does not fully adhere to said interior surface.

16. An urn for cremation remains, comprising:
a hard outer material for exposure to the outside atmosphere, said hard outer material having an interior surface defining an interior void and having an opening for the placement and removal of urn contents;
a lid sealingly disposed over said opening in said outer material; and
a flexible inner lining approximated to said interior surface.

17. The urn of claim 16, wherein said flexible inner lining does not adheres to said interior surface, such that when said urn is broken, pieces of said hard outer material release from said flexible lining and leave an intact container of lining material that protects the urn contents.

18. The urn of claim 16, wherein said flexible inner lining partly adheres to said interior side, such that when said urn is broken, some or all of the outer material pieces release from said flexible inner lining.
